(19) United States
(12) Patent Application Publication
(10) Pub. No.: US 2016/0155140 A1
(43) Pub. Date: Jun. 2, 2016

(54) SECURE CARD-LINKED OFFER AND LOYALTY AGGREGATION

(71) Applicant: 1Card Inc., Oak Brook, IL (US)

(72) Inventor: Richard Joseph DeNardis, Chicago, IL (US)

(21) Appl. No.: 14/557,664

(22) Filed: Dec. 2, 2014

(51) Int. Cl. G06Q 30/02

(52) U.S. Cl. CPC G06Q 30/0229

(57) ABSTRACT

An aspect of the invention includes receiving card data for a user of a website of an offer publisher. The offer publisher sources end users for offers aggregated from retailers, which offers are presented through the website. Another aspect includes storing the card data and a user identifier in a storage device, transmitting the card data to offer providers, each of which sources offers from the retailers, receiving a token from each of the offer providers as a proxy for the card data, and storing the token with the card data and the identifier. In response to a transaction between the user and the offer publisher with respect to an offer, a further aspect includes retrieving an offer identifier and the token from the storage device, and transmitting the offer identifier and the token to the offer provider in lieu of the card data to identify the user.

### BACKGROUND

The invention relates to data processing, and more specifically, to secure card-linked offer and loyalty aggregation.

Deal aggregators are popular destinations that display discounts on goods or services associated with a plurality of retailers in a single destination. These deal aggregation sites and mobile apps where consumers can access coupons, coupon codes and promotional offers, also referred to as offer publishers, typically interface with a plurality of deal providers who, in turn have relationships with retailers to source offer content. Publishers and deal providers receive a commission for each consumer who first visits the publisher's site, is then referred on to the retailer's site and completes a purchase. Commissions are tracked based on a cookie that is placed when the consumer clicks a link from the deal aggregator's site that takes the consumer to the retailer's site.

Recently, offers that can be found online or in a mobile application and linked to a user's credit card have become a popular means for shoppers to easily access digital offers not only online, but also in store without the need to print out a paper version of the offer. Unlike online deals, where commissions can be tracked with a cookie, these card-linked offers use the completion of a payment transaction via a payment card as a means to track the commission due to the offer's publisher. Additionally, payment card-linked loyalty programs have been created to enable consumers to receive discounts, points or track progress toward a reward (e.g., Buy 9 receive the 10^{th} purchase free) by linking the loyalty program to their payment cards.

In order to access card-linked offers from a publisher's site, a shopper must register their card number with the publisher and their deal providers. As the payment card number is sensitive information, publishers typically interface directly with a card-linked offer provider who receives the card number through means that do not require the publisher to transmit or store it. However, this approach requires consumers to input their card information for each provider of card-linked offers, which is time consuming and confusing to the publisher's users. What is needed, therefore, is a system that securely captures a consumer's card number once, stores it and provides it to multiple card-linked offer and loyalty providers in a manner that ensures the card number is protected.

### SUMMARY

According to embodiments of the invention, a method, system, and computer program product for implementing secure card-linked offer and loyalty aggregation is provided. The method includes receiving, at a computer processor as part of a registration process, card data for an end user of a website or mobile application of an offer publisher, the offer publisher sourcing end users as consumers of offers aggregated from multiple retailers, the offers presented through the website. The method also includes storing the card data and an identifier of the end user in a storage device; transmitting, by the computer processor, the card data to a plurality of card-linked offer provider systems, each of the plurality of card-linked offer provider systems sourcing offers from the multiple retailers; receiving a unique token, from each of the plurality of card-linked offer provider systems, as a proxy for the card data; and storing the unique token with the card data and the identifier in the storage device. In response to a transaction between the end user and the offer publisher, the transaction initiated in response to selection of a hypertext link by the end user with respect to an offer presented at the website, the method further includes retrieving an offer identifier corresponding to the offer and the token corresponding to the card data from the storage device, and transmitting the token and the offer identifier to the card-linked offer provider system in lieu of the card data to identify the end user of the transaction.

Additional features and advantages are realized through the techniques of the invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings, which:

FIG. 1 depicts a system upon which card-linked offer aggregation processes may be implemented in accordance with an embodiment of the invention;

FIG. 2 depicts a flow diagram of a process for implementing card-linked offer aggregation according to an embodiment of the invention; and

FIGS. 3A-3B depict records that are created for each end user of the card-linked offer aggregation services in accordance with an embodiment of the invention.

### DETAILED DESCRIPTION

Exemplary embodiments provide card-linked offer aggregation services. The card-linked offer aggregation services enable the acquisition, and provide for secure management, of consumer card information. The services provide a centralized facility that aggregates content from multiple card-linked offer providers, and provides the ability for the consumers to access offers and loyalty programs from a plurality of retailers at offer publisher websites to which the consumer's card information is securely linked. The services also employ tokens to uniquely identify a consumer to an offer publisher, such that the consumer's personal card information is not transmitted between the card-linked offer providers and the offer publisher each time an offer is selected, and the offer publisher can be compensated for transactions occurring through its website using the token to identify the consumer in lieu of the personal card information. These, and other, features of the card-linked offer aggregation processes will now be described.

It is understood in advance that although this disclosure includes a description of a client/server architecture, implementation of the teachings recited herein are not limited to a client/server environment. Rather, embodiments of the invention are capable of being implemented in conjunction with any other type of computing environment now known or later developed. By way of non-limiting example, the invention may be implemented via a cloud computing architecture. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

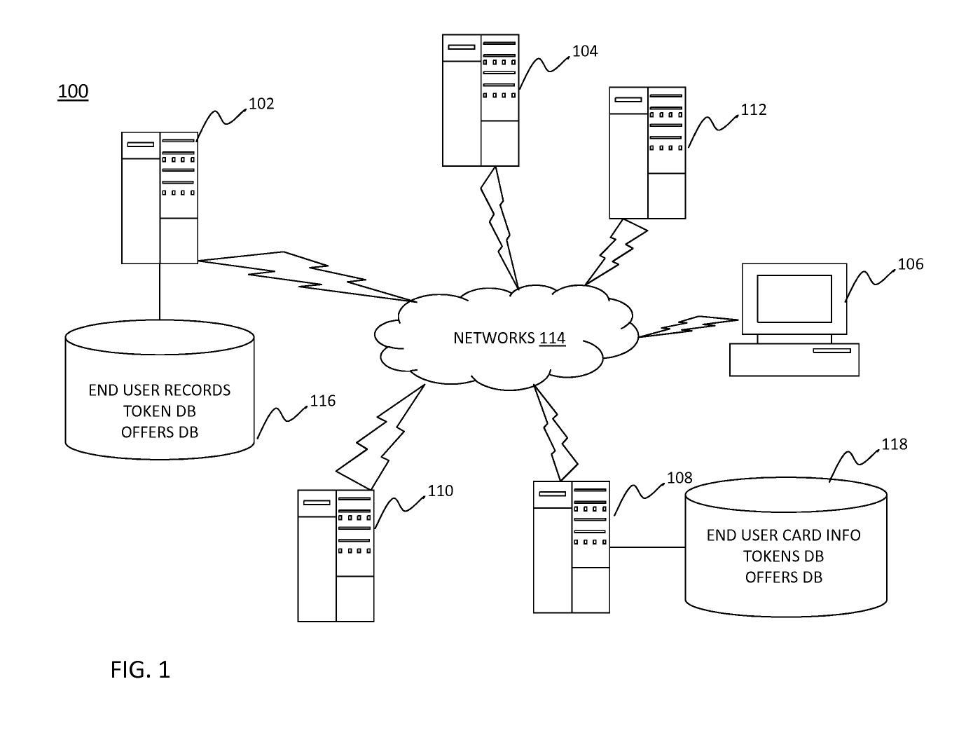

Turning now to FIG. 1, a system 100 upon which the card-linked offer aggregation processes may be implemented will now be described in an exemplary embodiment.

The system 100 includes a various network entities that are communicatively coupled to one or more networks 114. As shown in FIG. 1, the network entities include a card-linked offer aggregator system 102, an offer publisher system 104, an end user system 106, a card-linked offer provider system 108, a retail system 110, and a payment network system 112. While only a single instance of each of the systems 104-112 is shown in FIG. 1 for ease of illustration, it will be understood that multiple instances of each of the systems 104-112 may be present in order to realize the advantages of the embodiments described herein.

The card-linked offer aggregator system 102, offer publisher system 104, card-linked offer provider system 108, retailer system 110, and the payment network system 112, may each be implemented by a high-speed computer processing device (e.g., a mainframe computer or network server) for handling the volume of activities associated with users of the card-linked offer aggregation processes.

In one embodiment, the card-linked offer aggregator system 102 is a third-party provider of the card-linked offer aggregation services described herein. In this embodiment, the card-linked offer aggregator system 102 operates independently of the other network entities shown in FIG. 1 and provides the services, e.g., through an iframe on the publisher's website. In an alternative embodiment, the card-linked offer aggregator system 102 may be integrated with the offer publisher system 104 as a single entity to perform the services. The card-linked offer aggregator system 102 provides a centralized facility for tracking and managing multiple, independent card-linked offer providers, as described herein.

An offer publisher represents an entity that presents offers on behalf of multiple, independent retailers through a single website or online location. In this manner, an end user (also referred to herein as consumer) can view multiple different offers from multiple different retailers without having to individually access each retailer site. The offer publisher system 104 aggregates these offers from card-linked offer providers and online coupon providers. An example of an offer is a retailer-provided discount for a product or service. In an alternative embodiment, an offer may include a loyalty or reward program that includes incentives for driving repeat business by consumers at a particular retailer.

The end user system 106 may be may be operated by a consumer of products and/or services offered by retailers through the offer publisher's 104 website. In one embodiment, the end user system 106 is implemented as a general-purpose computer (e.g., personal computer or laptop). However, it will be understood that other types of electronic devices may be used to implement the end user system 106. For example, the end user system 106 may be a mobile device, such as a smart phone, personal digital assistant, or tablet PC. In one embodiment, the end user may access a website of the card-linked offer aggregation services that is provided by the card-linked offer aggregator system 102, or alternatively, the website of the offer publisher system 104 if the offer publisher system 104 implements an iframe for the card-linked offer aggregator system 102. The end user may register one or more payment cards with the card-linked offer aggregator system 102, as described further herein.

The card-linked offer provider system 108 may be operated by an entity that sources offers from multiple retailers. In an embodiment, the card-linked offer aggregator system 102 aggregates these offers from multiple card-linked offer providers, where each of the card-linked offer providers services a different set of retailers.

The retailer system 110 may be operated by an entity that sells goods and/or services to consumers, such as the end user of end user system 106. The retailer system 110 may be an online and/or brick and mortal establishment. In one embodiment, the retailer system 110 is a point of purchase system including one or more computer processors and may include, but is not limited to, elements such as a monitor, a printer (e.g., for receipts), a scanner device (e.g., barcode or quick response code reader), and a card reader (debit and/or credit). The retailer system 110 may include point of sale software that performs a variety of functions in addition to purchases, including but not limited to returns, exchanges, gift card issuance, loyalty program maintenance and coupon, discount program and promotions management.

The payment network system 112 may be operated by one or more payment card brands or financial institutions through which the end user holds one or more accounts (e.g., prepaid, debit card, credit card). The card-linked offer provider system 108 couples to the payment network system 112 over networks 114 to execute the offer (e.g., crediting the end user's account for the value of the offer).

The networks 114 may be any type of known networks including, but not limited to, a wide area network (WAN), a local area network (LAN), a global network (e.g. Internet), and an intranet. The network(s) 114 may be implemented to include wireless networking technologies or any kind of physical network implementation known in the art. The card-linked offer aggregator system 102, offer publisher system 104, end user system 106, card-linked offer provider system 108, retailer system 110, and payment network system 112 may each be coupled to network entities of the system 100 through multiple networks (e.g., Internet, intranet, and private network) so that not all systems are coupled through the same networks.

The system 100 of FIG. 1 also includes a storage device 116 communicatively coupled to the card-linked offer aggregator system 102. The storage device 116 may be implemented using a variety of devices for storing electronic information. It is understood that the storage device 116 may be implemented using memory contained in the card-linked offer aggregator system 102 or it may be a separate physical device, as illustrated in FIG. 1. The storage device 116 may be logically addressable as a consolidated data source across a distributed environment that includes the network(s) 114. Information stored in the storage device 116 may be retrieved and manipulated via the card-linked offer aggregator system 102 and other authorized users, if any.

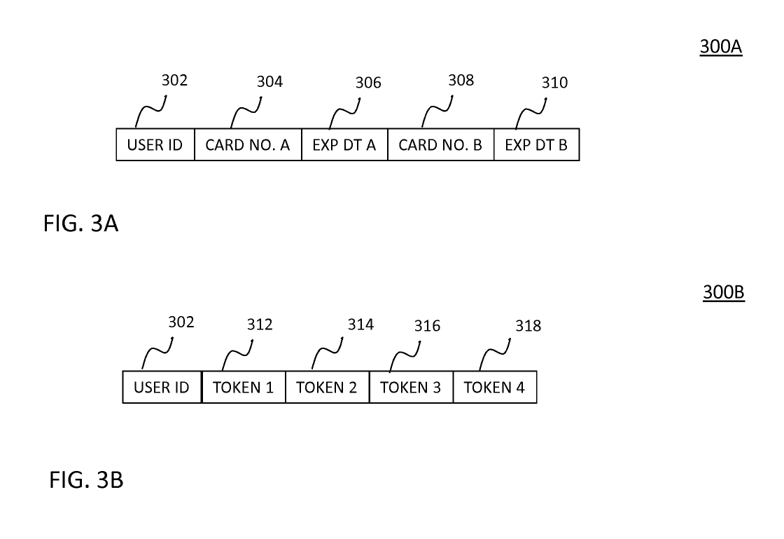

The storage device 116 houses end user records including card data linked to end user identifiers, as described further herein. The card data may include a card number (e.g., 16-digit account number) and expiration date of the card. The card may be a credit card or bank-issued debit card. In an embodiment, the card may be a loyalty card issued by a retailer. The storage device 116 also stores tokens provided by card-linked offer provider systems. The tokens are linked to the end user identifiers and may be stored in a separate database than the database storing the card data for security reasons. The storage device 116 may also store offers associated with each of a plurality of card-linked offer provider systems registered for the card-linked offer aggregation services. The offers are associated with identifiers (i.e., offer IDs) in the storage device 116. Sample records are shown in FIGS. 3A-3B.

In one embodiment, the system 100 also includes a storage device 118 that is communicatively coupled to the card-linked offer provider system 108. The storage device 118 stores card information associated with end users, as well as tokens that are generated by the card-linked offer provider system 108 for identifying the end users with respect to transactions conducted by the end users. In another embodiment, the card-linked offer provider system 108 passes the card number directly to the payment network system 112 and receives a token related to the card number.

The storage devices 116 and 118 are configured to comply with appropriate data security standards, such as Payment Card Industry Data Security Standard (PCI DSS).

The card-linked offer aggregator system 102 is configured to implement the card-linked offer aggregator processes described herein. In an embodiment, the card-linked offer aggregator system 102 executes logic for registering end users, registering card-linked offer providers, and for facilitating transactions with respect to offers provided by retailers via offer publisher sites associated with the registered card-linked offer provider system.

The card-linked offer aggregation services associate a unique identifier with each end user through, e.g., a registration process via an interface of the card-linked offer aggregator system 102. The card-linked offer aggregator system 102 generates and stores an end user record that includes the card information, and is accessible via the unique end user identifier. When a new card-linked offer provider system is registered with the card-linked offer aggregator system 102, the stored end user card data is transmitted to the card-linked offer provider system.

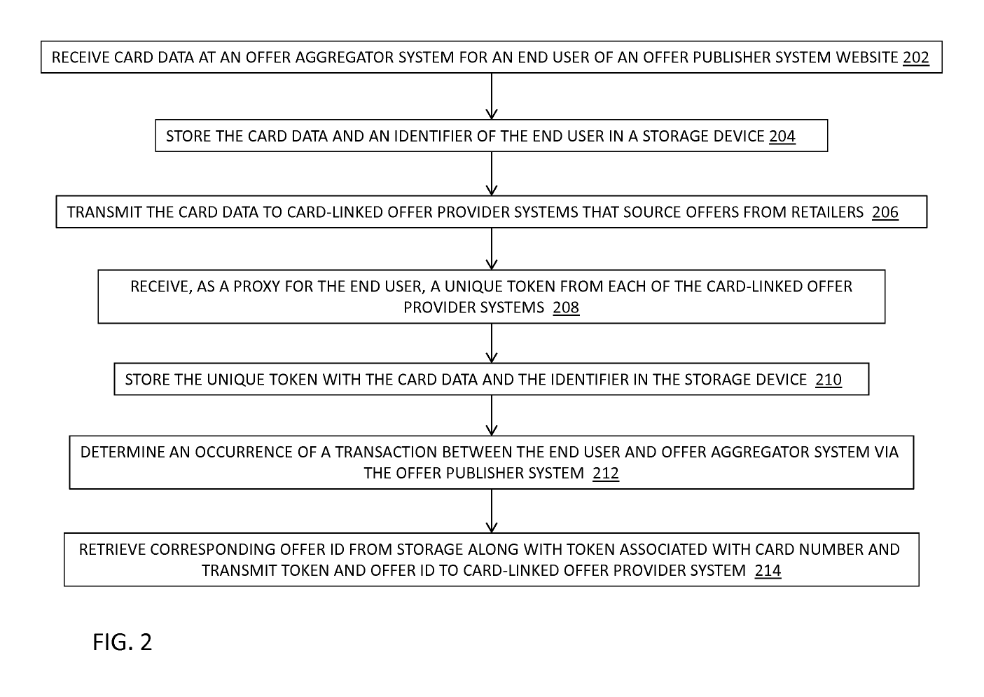

Turning now to FIG. 2, a flow diagram describing a process for implementing the card-linked offer aggregation services will now be described in an embodiment.

The card-linked offer aggregator system 102 receives a request from an end user system 106 to register for the card-linked offer aggregator services. At block 202, as part of the registration process, the card-linked offer aggregator system 102 receives card data for the end user of a web site or mobile application of an offer publisher system 104, which offer publisher is also managed by a registered card-linked offer provider system 108.

At block 204, the card-linked offer aggregator system 102 stores the card data and an identifier of the end user in the storage device 116. As indicated above, the storage device 116 may be PCI compliant to ensure the integrity of the personal data stored therein. The card data and identifier are stored in a record along with records corresponding to other registered end users.

At block 206, the card-linked offer aggregator system 102 transmits the card data to registered card-linked offer provider systems 108. Each of the providers generates a unique token for the end user that acts as a proxy for the end user and the card data. A separate token is generated for each card entered by the end user.

At block 208, the card-linked offer aggregator system 102 receives the unique tokens from the provider systems 108 and stores the unique tokens with the corresponding card data and end user identifiers in the storage device at block 210. As shown in FIG. 3A, for example, an end user record 300A includes an end user identification 302, a first card number 304, and an expiration date 306 of the first card number 304. In addition, as the end user has registered two cards in the example record of FIG. 3, the record 300 also includes a second card number 308, an expiration date 310 of the second card number 308, as well as a token 312, a token 314, a token 316 and a token 318. As shown in FIG. 3B, a second end user record 300B includes the end user identification 302, a token 312 generated by a first card-linked offer provider system 108 for the first card number 304 and a token 314 generated by the first card-linked offer provider system 108 for the second card number 308. Also shown in the record 300B is a token 316 generated by a second card-linked offer provider system 108 for the first card number 304 and a token 318 generated by the second card-linked offer provider system 108 for the second card number 306. The two records 300A and 300B may be linked, e.g., using the end user identifier 302 as a primary key.

At block 212, a transaction is determined between the end user system 106 and the card-linked offer aggregator 102, via an offer publisher system 104 (e.g., via the iframe). The transaction is initiated in response to selection of a hypertext link by the user with respect to an offer presented at the publisher's website. In response thereto, the card-linked offer aggregator system 102 accesses and retrieves the corresponding offer ID from storage system 116 along with the token corresponding to the card number 304 that is associated with offer provider system 108, and transmits the token and offer ID to the card-linked offer provider system 108 at block 214. Subsequently, in response to a purchase transaction between the end user system 106 and one of the multiple retailer systems 110 using the payment card associated with the card number (e.g., card 304 of FIG. 3A), the card-linked offer provider system 108 receives a notification of the purchase from the payment network 112 in order to enable the fulfillment of the offer.

As indicated above, the storage device 116 also stores a database of card-linked offer providers in response to a provider registration process. The card-linked offer aggregator system 102 transmits the card data to the card-linked offer provider system 108 in response to completion of the provider registration process and a determination that at least one offer from the card-linked offer provider system 108 is active on the offer publisher's website (e.g., is connected to a retailer that is currently offering goods or services at the offer publisher's website).

It will be understood that multiple cards can be registered by the end user. In this embodiment, the card-linked offer provider system 108 generates a unique token for each card. In an embodiment, when the end user system 106 selects an offer from the offer publisher's website, the end user is prompted to select which card he/she would like to use. A corresponding token is sent as notification to the offer publisher.

The card-linked offer aggregator services enable an end user to register card information one time only with the card-linked offer aggregator system 102. Since the card information is transmitted to multiple registered card-linked offer providers 108, which providers then maintain this information for its associated offer publishers and retailers, the user is able to receive and engage in multiple offers from a variety of different retailers through multiple registered offer providers' websites without requiring the user to enter the card information when performing the offer transaction. The card-linked offer provider-generated tokens are used as a proxy for the card information, which provides a greater level of security throughout the offer transaction.

In an embodiment, the card data of an end user can be provided to the card-linked offer aggregator system 102 by a financial institution through which the end user holds an account. In this embodiment, the financial institution may represent the offer publisher.

The redemption by the end user may occur online at a retailer website or in person at a physical location of the retailer. The offer may be linked online via the offer publisher's website or mobile application. However, once the offer is linked to the user's card information, the end user may enter the physical retail store, present the card to a point of purchase system, and the point of purchase system completes the transaction.

Technical effects and benefits include enabling the acquisition and secure management of consumer card information, providing a centralized facility that aggregates offer content from multiple card-linked offer providers, and provides the ability for the consumers to access offers from a plurality of retailers from card-linked offer providers to which the consumer's card information is securely linked. Other technical effects and benefits include utilizing tokens to uniquely identify a consumer to offer publishers, such that the consumer's personal card information is not transmitted between the card-linked offer providers and the offer publishers in order for the offer publishers to receive compensation for the executed transactions.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the invention may be written in any combination of one or more programming languages, including an object oriented programming language such as Java, HTML, JavaScript, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus to provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to the diagrams or the steps (or operations) described therein without departing from the spirit of the invention. For instance, the steps may be performed in a differing order or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method, comprising:
receiving, at a computer processor as part of a registration process, card data for an end user of a website or mobile application of an offer publisher, the offer publisher sourcing end users as consumers of offers aggregated from multiple retailers, the offers presented through the website;
storing the card data and an identifier of the end user in a storage device;
transmitting, by the computer processor, the card data to a plurality of card-linked offer provider systems, each of the plurality of card-linked offer provider systems sourcing offers from the multiple retailers;
receiving a unique token, from each of the plurality of card-linked offer provider systems, as a proxy for the card data;
storing the unique token with the card data and the identifier of the end user in the storage device;
in response to a transaction between the end user and the offer publisher, the transaction initiated in response to selection of a hypertext link by the end user with respect to an offer presented at the website, retrieving an offer identifier corresponding to the offer and the token corresponding to the card data from the storage device, and transmitting the token and the offer identifier to the card-linked offer provider system in lieu of the card data to identify the end user of the transaction.

2. The method of claim 1, further comprising:
storing, in the storage device, a database of card-linked offer providers in response to a provider registration process;
wherein transmitting the card data to the card-linked offer provider systems is performed in response to completion of the provider registration process and a determination that at least one offer from the card-linked offer provider systems is active on the website.

3. The method of claim 1, wherein the receiving the card data from the end user includes receiving card data for multiple cards, and a unique token is received for each of the multiple cards.

4. The method of claim 3, wherein the transaction is effectuated via an end user-selected one of the multiple cards, and the corresponding unique token is transmitted to the offer publisher.

5. The method of claim 1, wherein the card data is received from the end user one time only at the time of the registration process.

6. The method of claim 1, wherein the card data is received from a financial institution one time only in lieu of the an end user driven registration process, the end user holds an account with the financial institution, and the financial institution represents a card-linked offer provider system.

7. The method of claim 1, wherein the offer is redeemable by the end user in person at a physical location of the retailer.

8. The method of claim 1, wherein the offer is redeemable by the end user via the online site of a retailer.

9. A system, comprising:
a computer memory; and
a computer processor, the computer processor configured to:
receive, as part of a registration process, card data for an end user of a website or mobile application of an offer publisher, the offer publisher sourcing end users as consumers of offers aggregated from multiple retailers, the offers presented through the website;
store the card data and an identifier of the end user in a storage device;
transmit the card data to a plurality of card-linked offer provider systems, each of the plurality of card-linked offer provider systems sourcing offers from the multiple retailers;
receive a unique token, from each of the plurality of card-linked offer provider systems, as a proxy for the card data;
store the unique token with the card data and the identifier of the end user in the storage device;
in response to a transaction between the end user and the offer publisher, the transaction initiated in response to selection of a hypertext link by the end user with respect to an offer presented at the website, retrieve an offer identifier corresponding to the offer and the token corresponding to the card data from the storage device, and transmit the token and the offer identifier to the card-linked offer provider system in lieu of the card data to identify the end user of the transaction.

10. The system of claim 9, wherein the computer processor is further configured to:
store, in the storage device, a database of card-linked offer providers in response to a provider registration process;
wherein transmitting the card data to the card-linked offer provider systems is performed in response to completion of the provider registration process and a determination that at least one offer from the card-linked offer provider systems is active on the website.

11. The system of claim 9, wherein receiving the card data from the end user includes receiving card data for multiple cards, and a unique token is received for each of the multiple cards.

12. The system of claim 11, wherein the transaction is effectuated via an end user-selected one of the multiple cards, and the corresponding unique token is transmitted to the offer publisher.

13. The system of claim 9, wherein the card data is received from the end user one time only at the time of the registration process.

14. The system of claim 9, wherein the card data is received from a financial institution one time only in lieu of the an end user driven registration process, the end user holds an account with the financial institution, and the financial institution represents a card-linked offer provider system.

15. The system of claim 9, wherein the offer is redeemable by the end user in person at a physical location of the retailer.

16. The system of claim 9, wherein the offer is redeemable by the end user via the online site of a retailer.

17. A computer program product comprising a non-transitory computer-readable storage medium having instructions embodied thereon, which when executed by a computer processor, cause the computer processor to implement a method, the method comprising:
receiving, as part of a registration process, card data for an end user of a website or mobile application of an offer publisher, the offer publisher sourcing end users as consumers of offers aggregated from multiple retailers, the offers presented through the website;
storing the card data and an identifier of the end user in a storage device;
transmitting the card data to a plurality of card-linked offer provider systems, each of the plurality of card-linked offer provider systems sourcing offers from the multiple retailers;
receiving a unique token, from each of the plurality of card-linked offer provider systems, as a proxy for the card data;
storing the unique token with the card data and the identifier of the end user in the storage device;
in response to a transaction between the end user and the offer publisher, the transaction initiated in response to selection of a hypertext link by the end user with respect to an offer presented at the website, retrieving an offer identifier corresponding to the offer and the token corresponding to the card data from the storage device, and transmitting the token and the offer identifier to the card-linked offer provider system in lieu of the card data to identify the end user of the transaction.

18. The computer program product of claim 17, wherein the method further comprises:
storing, in the storage device, a database of card-linked offer providers in response to a provider registration process;
wherein transmitting the card data to the card-linked offer provider systems is performed in response to completion of the provider registration process and a determination that at least one offer from the card-linked offer provider systems is active on the website.

19. The computer program product of claim 17, wherein the receiving the card data from the end user includes receiving card data for multiple cards, and a unique token is received for each of the multiple cards.

20. The computer program product of claim 19, wherein the transaction is effectuated via an end user-selected one of the multiple cards, and the corresponding unique token is transmitted to the offer publisher.

21. The computer program product of claim 17, wherein the card data is received from the end user one time only at the time of the registration process.

22. The computer program product of claim 17, wherein the card data is received from a financial institution one time only in lieu of the an end user driven registration process, the end user holds an account with the financial institution, and the financial institution represents a card-linked offer provider system.

23. The computer program product of claim 17, wherein the offer is redeemable by the end user in person at a physical location of the retailer.

24. The computer program product of claim 17, wherein the offer is redeemable by the end user via the online site of a retailer.
